(19) United States
(12) Patent Application Publication
(10) Pub. No.: US 2024/0046149 A1
(43) Pub. Date: Feb. 8, 2024

(54) ANALYZING MEASUREMENT RESULTS OF A TARGET SYSTEM

(71) Applicant: Elisa Oyj, Helsinki (FI)

(72) Inventors: Viivi UURTIO, Helsinki (FI); Qi YU, Helsinki (FI); Rasmus HEIKKILÄ, Helsinki (FI); Petteri LUNDÉN, Helsinki (FI); Antti LISKI, Helsinki (FI)

(73) Assignee: Elisa Oyj, Helsinki (FI)

(21) Appl. No.: 18/267,195

(22) PCT Filed: Nov. 29, 2021
(86) PCT No.: PCT/FI2021/050820

§ 371 Date: Jun. 14, 2023

(30) Foreign Application Priority Data
Dec. 18, 2020 (FI) 20206329

(51) Int. Cl. G06N 20/00; G06F 17/16

(52) U.S. Cl. CPC G06N 20/00; G06F 17/16

(57) ABSTRACT

Analyzing measurement results of a target system. The analysis is performed by receiving a first matrix including first measurement results of the target system; training a matrix decomposition model with the first matrix to obtain a third matrix of normal or stable measurement results and a fourth matrix of anomalous or unstable measurement results; receiving a second matrix including second measurement results of the target system, wherein the second measurement results are later measurement results compared to the first measurement results; selecting from the third matrix a subset that matches with the second matrix; subtracting the selected subset from the second matrix to obtain a fifth matrix; outputting the fifth matrix or information derived from the fifth matrix for the purpose of evaluating performance of the target system.

### TECHNICAL FIELD

The present application generally relates to analyzing measurement results of a target system.

### BACKGROUND

This section illustrates useful background information without admission of any technique described herein representative of the state of the art.

There are various automated measures that monitor operation of complex target systems, such as communications networks or industrial processes, in order to detect problems so that corrective actions can be taken.

For example anomaly detection models may be used for analyzing the measurement results to identify anomalous measurement results or data points that stand out from the rest of the data. Anomaly detection refers to identification of data points, items, observations, events or other variables that do not conform to an expected pattern of a given data sample or data vector. Anomaly detection models can be trained to learn the structure of normal data samples. The models output an anomaly score for an analysed sample, and the sample is classified as an anomaly, if the anomaly score exceeds some predefined threshold. There are various unsupervised and semi-supervised learning models that can be used in anomaly detection. Such models include for example k nearest neighbors (kNN), local outlier factor (LOF), principal component analysis (PCA), kernel principal component analysis, independent component analysis (ICA), isolation forest, autoencoder, angle-based outlier detection (ABOD), and others. Different models represent different hypotheses about how anomalous points stand out from the rest of the data.

Now a new approach is provided for analyzing measurement results of a target system.

### SUMMARY

The appended claims define the scope of protection. Any examples and technical descriptions of apparatuses, products and/or methods in the description and/or drawings not covered by the claims are presented not as embodiments of the present disclosure but as background art or examples useful for understanding the present disclosure.

According to a first example aspect there is provided a computer implemented method for analyzing measurement results of a target system. The method comprises
receiving a first matrix comprising first measurement results of the target system;
training a matrix decomposition model with the first matrix to obtain a third matrix of normal or stable measurement results and a fourth matrix of anomalous or unstable measurement results;
receiving a second matrix comprising second measurement results of the target system, wherein the second measurement results are later measurement results compared to the first measurement results;
selecting from the third matrix a subset that matches with the second matrix;
subtracting the selected subset from the second matrix to obtain a fifth matrix;
outputting the fifth matrix or information derived from the fifth matrix for the purpose of evaluating performance of the target system.

In some example embodiments, the information derived from the fifth matrix comprises an aggregated score for each row of the fifth matrix.

In some example embodiments, the target system is a communications network. In an alternative embodiment, the target system is an industrial process.

In yet another embodiment, the target system is a life science application.

In some example embodiments, each row of the matrices relates to respective one or more properties.

In some example embodiments, the first and second matrices are accompanied with a property matrix comprising a combination of properties for each row of the first and second matrices, and wherein the subset that matches the second matrix is selected based on respective combinations of properties.

In some example embodiments, the properties comprise one or more of the following: time, location, device type, device identifier, logical element, event type, management system.

In some example embodiments, the target system is a communications network and the properties comprise one or more of the following: time, location, subscriber type, subscription type, network technology, cell type, cell identifier, device type, device identifier, logical element, event type, antenna type, roaming network, management system.

In some example embodiments, the first measurement results comprise measurement results for a 24 hour time period or multiple thereof.

In some example embodiments, each row of the first and second matrices comprise measurement results aggregated over a 5-30 minute time period.

In some example embodiments, wherein the second measurement results comprise measurement results for a 5-30 time minute period or multiple thereof.

In some example embodiments, the first measurement results of the first matrix comprise measurement results of a previous day and the second measurement results of the second matrix comprise at least part of measurement results of a current day.

According to a second example aspect of the present disclosure, there is provided an apparatus comprising a processor and a memory including computer program code; the memory and the computer program code configured to, with the processor, cause the apparatus to perform the method of the first aspect or any related embodiment.

According to a third example aspect of the present disclosure, there is provided a computer program comprising computer executable program code which when executed by a processor causes an apparatus to perform the method of the first aspect or any related embodiment.

According to a fourth example aspect there is provided a computer program product comprising a non-transitory computer readable medium having the computer program of the third example aspect stored thereon.

According to a fifth example aspect there is provided an apparatus comprising means for performing the method of the first aspect or any related embodiment.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows an example scenario according to an example embodiment;

FIG. 2 shows a block diagram of an apparatus according to an example embodiment; and

FIGS. 3 and 4 illustrate example methods according to certain embodiments.

### DETAILED DESCRIPTION

In the following description, like reference signs denote like elements or steps.

A challenge in analyzing measurement results from complex target systems, such as communications networks or industrial processes or life science applications, is that the amount of data is huge and therefore identification of most relevant anomalous measurement results is not an easy task.

In the context of present disclosure, measurement results of a target system may involve sensor data and/or performance data such as pressure, temperature, manufacturing time, yield of a production phase etc. of an industrial process, or sensor data and/or performance data such as key performance indicator values, signal level, number of users, number of dropped connections etc. from a communications network. Still further, the measurement results of a target system may involve patient test results and/or sensor data from sensors monitoring patients.

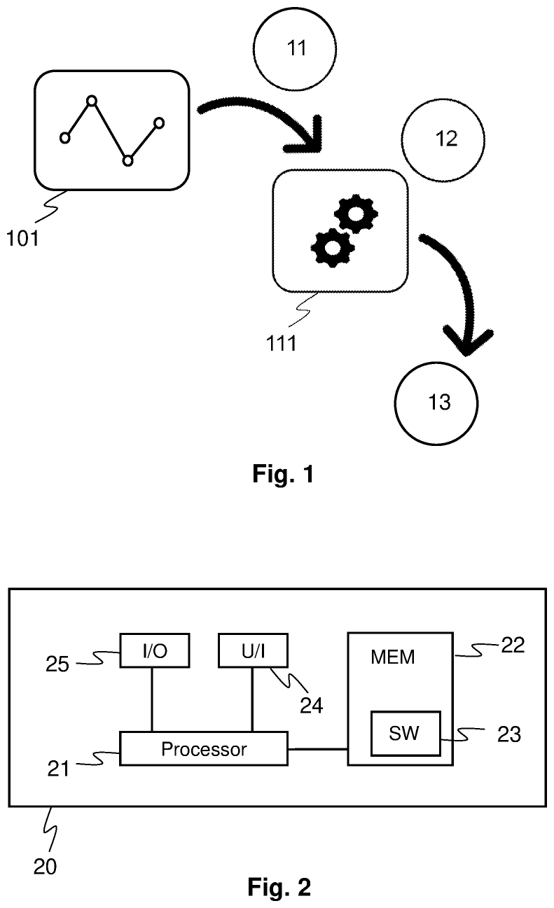

FIG. 1 shows an example scenario according to an embodiment. The scenario shows a controllable target system 101 and an automation system 111 configured to implement analysis of measurement results according to example embodiments. The target system 101 may be a communications network comprising a plurality of physical network sites comprising base stations and other network devices, or the target system 101 may be an industrial process, such as a semiconductor manufacturing process. The automation system 111 is configured to implement at least some example embodiments of present disclosure.

In an embodiment of the present disclosure the scenario of FIG. 1 operates as follows: In phase 11, the automation system 111 receives measurement results from the target system 101. In phase 12, the automation system 111 analyzes the measurement results, and in phase 13, the automation system 111 outputs the results of the analysis. This output may then be used for manually or automatically controlling the target system 101.

The process in the automation system 111 may be manually or automatically triggered. Further, the process in the automation system 111 may be periodically or continuously repeated.

FIG. 2 shows a block diagram of an apparatus 20 according to an embodiment. The apparatus 20 is for example a general-purpose computer or server or some other electronic data processing apparatus. The apparatus 20 can be used for implementing at least some embodiments of the present disclosure. That is, with suitable configuration the apparatus 20 is suited for operating for example as the automation system 111 of foregoing disclosure.

The apparatus 20 comprises a communication interface 25; a processor 21; a user interface 24; and a memory 22. The apparatus 20 further comprises software 23 stored in the memory 22 and operable to be loaded into and executed in the processor 21. The software 23 may comprise one or more software modules and can be in the form of a computer program product.

The processor 21 may comprise a central processing unit (CPU), a microprocessor, a digital signal processor (DSP), a graphics processing unit, or the like. FIG. 2 shows one processor 21, but the apparatus 20 may comprise a plurality of processors.

The user interface 24 is configured for providing interaction with a user of the apparatus. Additionally or alternatively, the user interaction may be implemented through the communication interface 25. The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 may comprise for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories. The memory 22 may serve the sole purpose of storing data, or be constructed as a part of an apparatus 20 serving other purposes, such as processing data.

The communication interface 25 may comprise communication modules that implement data transmission to and from the apparatus 20. The communication modules may comprise a wireless or a wired interface module(s) or both. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. The communication interface 25 may support one or more different communication technologies. The apparatus 20 may additionally or alternatively comprise more than one of the communication interfaces 25.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like. Further, it is noted that only one apparatus is shown in FIG. 2, but the embodiments of the present disclosure may equally be implemented in a cluster of shown apparatuses.

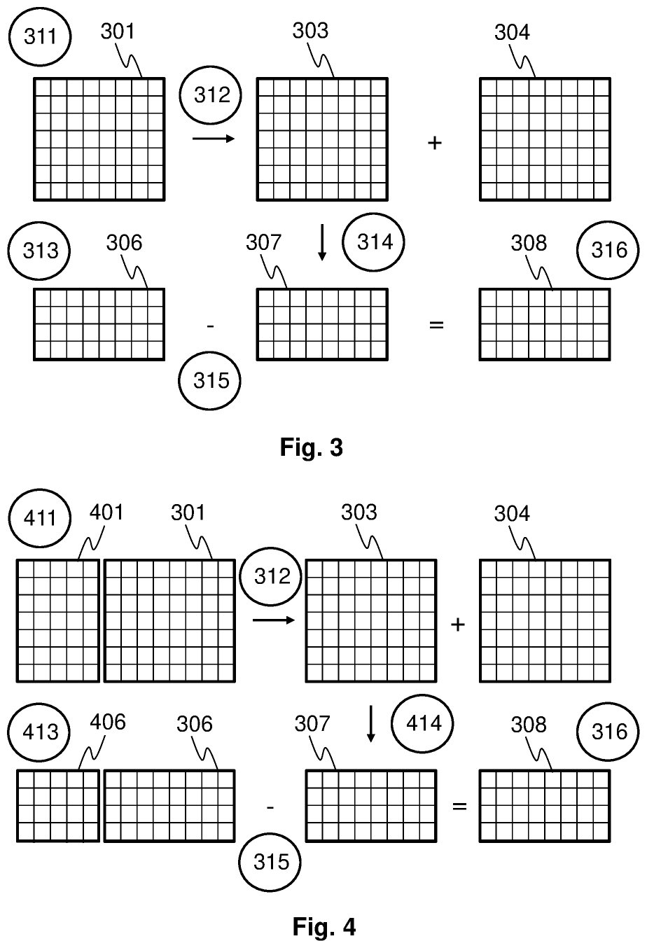

FIGS. 3 and 4 illustrate example methods according to certain embodiments. The methods may be implemented in the automation system 111 of FIG. 1 and/or in the apparatus 20 of FIG. 2. The methods are implemented in a computer and do not require human interaction unless otherwise expressly stated. It is to be noted that the methods may however provide output that may be further processed by humans and/or the methods may require user input to start.

The example of FIG. 3 comprises the following phases:
311: A first matrix 301 is received. The first matrix comprises first measurement results of the target system.

In an embodiment, the first matrix covers measurement results for a 24 hour time period or a multiple of 24 hour time periods. Each row of the first matrix may comprise aggregated measurement results over a 15 minute time period or over a 5-30 minute time period, but equally some other time period could be covered by each row of the matrix. The aggregation may be based on sum of values, mean of values or standard deviation of values. Additionally or alternatively, the values of the matrix may be centered so that every column of the matrix has zero mean and unit variance. Still further, the values of the matrix may be rounded.
312: A matrix decomposition model is trained with the first matrix 301 to obtain a third matrix 303 of normal or stable measurement results (or non-anomalous measurement results or measurement results not likely to cause problems) and a fourth matrix 304 of anomalous or unstable measurement results.

For example low-rank and sparse decomposition algorithms, robust PCA (Principal Component Analysis) or robust autoencoders can be used for this purpose. Robust autoencoders are discussed for example in Pu, Jie, Yannis Panagakis, and Maja Pantic. “Learning low rank and sparse models via robust autoencoders.” ICASSP 2019-2019 IEEE International Conference on Acoustics, Speech and Signal Processing (ICASSP). IEEE, 2019. Robust PCA is discussed for example in Candes, Emmanuel J., et al. “Robust principal component analysis?.” Journal of the ACM (JACM) 58.3 (2011): 1-37, and in Bouwmans, Thierry, et al. “On the applications of robust PCA in image and video processing.” Proceedings of the IEEE 106.8 (2018): 1427-1457.

A straightforward solution might be to treat the fourth matrix 304 as a result of the analysis, but in present disclosure this is not the case. Instead, in present disclosure the result of the decomposition is used for analyzing later data.
313: A second matrix 306 is received. The second matrix comprises second measurement results of the target system. The second measurement results are later measurement results compared to the first measurement results.

The second matrix is obtained the same way as the first matrix, but over a different time period. That is, the first measurement results and the second measurement results relate to measurement of the same phenomena or the same target over different time periods. In an example embodiment, the first matrix covers measurements of the previous day and the second matrix covers at least part of measurements of the current day.
314: A subset 307 of the third matrix 303 is selected. The subset 307 is selected so that it matches the second matrix 306.
315: The subset 307 is subtracted from the second matrix 306 to obtain a fifth matrix 308.
316: The fifth matrix 308 or at least information derived from the fifth matrix 308 is output. The fifth matrix essentially identifies anomalies present in the second matrix. The output may then be used in management of the communications network to fix the identified anomalies and/or to perform corrective actions that may be necessary. That is, the identified anomalies may be provided for the purpose of performing corrective actions in the target system. The corrective actions may be for example parameter adjustments, component replacements, restarting devices and the like.

The information derived from the fifth matrix 308 may comprise for example an aggregated score for each row of the fifth matrix. E.g. sum over the values of the row may be used. The row with the highest score may then be considered most anomalous result.

In general, each row of the different matrices relates to respective one or more properties. The properties define operating context in which respective measurement result is obtained. The following is non-exclusive list of possible properties: time, location, device type, device identifier, logical element, event type, product type, production phase, production equipment, management system. In the context of communications network the following properties may be additionally or alternatively used: subscriber type, subscription type, network technology, cell type, cell identifier, antenna type, roaming network. Other properties may be used, too.

The subset 307 may be selected based on properties related to the rows of the second matrix 306. That is, such rows of the third matrix may be selected for the subset that have at least partially the same properties as rows of the second matrix. In an example embodiment, the property is time and the subset 307 is selected by selecting from the third matrix 303 rows that have corresponding time stamp with the rows of the second matrix 306.

By using the matrix decomposition methods as defined in the method of FIG. 3 and by comparing current measurement results (the second matrix) to earlier detected normal or stable measurement results, ongoing analysis of current measurement result is enabled. It is assumed that what was normal or stable the day before is likely to be normal or stable today too.

The example of FIG. 4 is similar to the example of FIG. 3 except that the measurement result matrices (the first and the second matrix) are accompanied with respective property matrices comprising a combination of properties for each row of the first and second matrices. Each row is related to a certain incident defined by the combination of the properties.

The following is non-exclusive list of possible properties: time, location, device type, device identifier, logical element, event type, product type, production phase, production equipment, management system. In the context of communications network the following properties may be additionally or alternatively used: subscriber type, subscription type, network technology, cell type, cell identifier, antenna type, roaming network. Other properties may be used, too.

It is to be noted that the amount of possible incidents may be very large. For example in the context of communications network, there may be 40 000 different incidents substantially at the same time. If each incident is considered for example every 15 minutes, the amount of data increases quickly. Based on this it is clear that the amount of measurement result to analyze may be significantly large.

The example of FIG. 4 comprises the following phases:
411: A first matrix 301 and a respective first property matrix 401 are

received. The first matrix comprises first measurement results of the target system the same way as in phase 311 of FIG. 3.
312: The same way as in FIG. 3, a matrix decomposition model is trained with the first matrix 301 to obtain a third matrix 303 of normal or stable measurement results (or non-anomalous measurement results or measurement results not likely to cause problems) and a fourth matrix 304 of anomalous or unstable measurement results.

For the sake of clarity it is noted that the property matrix 401 applies to the third and fourth matrices as well. That is, the rows of the matrices 303 and 304 relate to the incidents defined by respective combination of properties of the property matrix.
413: A second matrix 306 and a respective second property matrix 406 are received. The second matrix comprises second measurement results of the target system the same way as in phase 313 of FIG. 3.

The second property matrix 406 has corresponding structure with the first property matrix 401.
414: A subset 307 of the third matrix 303 is selected. The subset 307 is selected based on the combination of properties defined in the first and second property matrices 401 and 406. For each row of the second property matrix, at least almost similar incident is searched for in the first property matrix and corresponding rows of the third matrix 303 are selected for the subset 307. It is to be noted that exactly the same combination of properties is not required. Instead, certain variation can be accepted.
315: The same way as in FIG. 3, the subset 307 is subtracted from the second matrix 306 to obtain a fifth matrix 308.
316: The same way as in FIG. 3, the fifth matrix 308 or at least information derived from the fifth matrix 308 is output.

By arranging the measurement results by the incidents, the analysis may improve as the outcome of the analysis directly provides combination of properties that may have a problem and should be considered for possible corrective actions.

In the following, a practical example is discussed. The example relates to a communications network. Measurement results that are considered in the example comprise the following variables: moc_drops, moc_answers, lu_failures, lu_attempts, call_setup_failures, mtc_drops, mtc_answers, and mtc_attempts, wherein moc=mobile originated call, lu=location update, and mtc=mobile terminated call. These variables are readily available from communications networks.

Table 1 shows a first matrix of first measurement results. The values of the first matrix are centered so that each column has zero mean and unit variance.

TABLE 1
First matrix (first measurement results)

| | | moc | | lu | call | | mtc | mtc |
|---|---|---|---|---|---|---|---|---|
| row | moc | an- | lu | at- | setup | mtc | an- | at- |
| no | drops | swers | failures | tempts | failures | drops | swers | tempts |
| 1 | 1.9 | −0.16 | 1.2 | 1 | −0.82 | 1.5 | 1.5 | 0.84 |
| 2 | 0.21 | 1.8 | 1.2 | −1 | 1.2 | −0.65 | −0.65 | 0.17 |
| 3 | 0.21 | 0.16 | −0.82 | −1 | −0.82 | −0.65 | 1.5 | 2.2 |
| 4 | 1.4 | 1.8 | −0.82 | 1 | 1.2 | 1.5 | 1.5 | 0.84 |
| 5 | −1.4 | −0.82 | 1.2 | 1 | 1.2 | −0.65 | −0.65 | −1.2 |
| 6 | −1 | −1.2 | 1.2 | 1 | −0.82 | −0.65 | −0.65 | −1.2 |
| 7 | −0.21 | −0.16 | −0.82 | −1 | −0.82 | −0.65 | −0.65 | −0.5 |
| 8 | −0.21 | −0.16 | −0.82 | −1 | −0.82 | −0.65 | −0.65 | −0.17 |
| 9 | 0.21 | −0.16 | −0.82 | −1 | −0.82 | −0.65 | −0.65 | −0.17 |
| 10 | −1 | −1.2 | −0.82 | 1 | 1.2 | 1.5 | −0.65 | −0.84 |

The first matrix is accompanied with a first property matrix shown in Table 2. The first property matrix comprises combination of the following properties for each row of the first matrix: logical element, event type, cell id, roaming network, subscription type, network technology, and management system. Possible logical elements comprise RANAP (Radio Access Network Application Part), DTAP CC (Direct Transfer Application Part CC), and BSSMAP (Base Station System Management Application Part). Event type refers in this example to a release reason (final state of a signal). Management system in this example can be EMSS4 or EMSS5 (Element Management System).

TABLE 2
Property matrix of the first matrix

| row | logical | | | roaming | subscription | network | management |
|---|---|---|---|---|---|---|---|
| no | element | event type | cell id | network | type | technology | system |
| 1 | RANAP | Fail in radio | cell 1 | not | postpaid | 3G | EMSS4 |
| | | interface | | roaming | | | |
| | | procedure | | | | | |
| 2 | DTAP CC | Incompatible | cell 2 | not | postpaid | 3G | EMSS4 |
| | | destination | | roaming | | | |
| 3 | RANAP | Invalid RAB | cell 3 | not | postpaid | 3G | EMSS5 |
| | | parameters | | roaming | | | |
| 4 | BSSMAP | Radio | cell 4 | not | postpaid | 2G | EMSS5 |
| | | interface fail | | roaming | | | |
| 5 | RANAP | Normal | cell 5 | not | prepaid | 3G | EMSS5 |
| | | release | | roaming | | | |
| 6 | DTAP CC | Normal cell | cell 6 | not | postpaid | 3G | EMSS5 |
| | | clearing | | roaming | | | |
| 7 | BSSMAP | Radio | cell 4 | not | postpaid | 2G | EMSS5 |
| | | interface fail | | roaming | | | |
| 8 | DTAP CC | Incompatible | cell 2 | not | postpaid | 3G | EMSS4 |
| | | destination | | roaming | | | |
| 9 | RANAP | Fail in radio | cell 1 | not | postpaid | 3G | EMSS4 |
| | | interface | | roaming | | | |
| | | procedure | | | | | |
| 10 | RANAP | Successful | cell 7 | not | postpaid | 3G | EMSS4 |
| | | relocation | | roaming | | | |

Tables 3 and 4 show result of decomposition of the first matrix. It is to be noted that the rows and the property combinations of the property matrix of Table 2 are associated with respective rows of the decomposition results, too.

TABLE 3
Third matrix (normal measurement results)

| | | moc | | lu | call | | mtc | mtc |
|---|---|---|---|---|---|---|---|---|
| row | moc | an- | lu | at- | setup | mtc | an- | at- |
| no | drops | swers | failures | tempts | failures | drops | swers | tempts |
| 1 | 0.8 | 0.06 | 0.47 | 1 | −0.08 | 1.3 | 1.4 | 0.84 |
| 2 | 0.21 | 0.73 | 0.2 | −0.85 | 0.29 | −0.65 | −0.34 | 0.17 |
| 3 | 0.24 | 0.16 | −0.8 | −1 | −0.82 | −0.31 | −0.21 | 0.28 |
| 4 | 0.9 | 0.78 | −0.08 | 0.92 | 0.89 | 1.5 | 1.3 | 0.84 |
| 5 | −1.1 | −0.82 | 1.2 | 1 | 0.81 | −0.56 | −0.65 | −1.1 |
| 6 | −1 | −1.1 | 0.84 | 0.62 | −0.12 | −0.65 | −0.65 | −1 |
| 7 | −0.21 | −0.16 | −0.82 | −1 | −0.82 | −0.65 | −0.65 | −0.17 |
| 8 | −0.21 | −0.16 | −0.82 | −1 | −0.82 | −0.65 | −0.65 | −0.17 |
| 9 | −0.21 | −0.16 | −0.82 | −1 | −0.82 | −0.65 | −0.65 | −0.17 |
| 10 | −0.81 | −0.74 | 0.1 | 1 | 0.54 | 0.18 | −0.3 | −0.84 |

TABLE 4
Fourth matrix (anomalous measurement results)

| | | moc | | lu | call | | mtc | mtc |
|---|---|---|---|---|---|---|---|---|
| row | moc | an- | lu | at- | setup | mtc | an- | at- |
| no | drops | swers | failures | tempts | failures | drops | swers | tempts |
| 1 | 1.1 | −0.22 | 0.76 | 0 | −0.74 | 0.26 | 0.14 | 0 |
| 2 | 0 | 1.1 | 1 | −0.15 | 0.93 | −0 | −0.31 | 0 |
| 3 | −0.03 | 0 | −0.02 | −0 | −0 | −0.34 | 1.7 | 1.9 |
| 4 | 0.55 | 1 | −0.74 | 0.08 | 0.33 | 0 | 0.24 | −0 |
| 5 | −0.34 | −0 | 0 | 0 | 0.42 | −0.1 | 0 | −0.03 |
| 6 | −0 | −0 | 0.38 | 0.38 | −0.69 | −0 | −0 | −0.17 |
| 7 | 0 | −0 | −0 | −0 | −0 | −0 | −0 | −0.34 |
| 8 | −0 | −0 | −0 | −0 | −0 | −0 | −0 | −0 |
| 9 | 0.41 | −0 | −0 | −0 | −0 | −0 | −0 | −0 |
| 10 | −0.22 | −0.42 | −0.92 | 0 | 0.68 | 1.4 | −0.35 | −0 |

Table 5 shows a second matrix of second measurement results. The second matrix comprises the same variables as the first matrix and the values of the second matrix are centered using the mean and standard deviation values of the columns of the first matrix.

TABLE 5
Second matrix (second measurement results)

| | | moc | | lu | call | | mtc | mtc |
|---|---|---|---|---|---|---|---|---|
| row | moc | an- | lu | at- | setup | mtc | an- | at- |
| no | drops | swers | failures | tempts | failures | drops | swers | tempts |
| 1 | −1 | −0.82 | 1.2 | 1 | −0.82 | −0.65 | −0.65 | −1.2 |
| 2 | −1 | −0.82 | 1.2 | 1 | 1.2 | −0.65 | 1.5 | −1.2 |
| 3 | 0.62 | −0.16 | −0.82 | −1 | −0.82 | −0.65 | −0.65 | 1.2 |
| 4 | 1.4 | 0.49 | −0.82 | −1 | −0.82 | −0.65 | −0.65 | −0.17 |
| 5 | −0.21 | 1.8 | −0.82 | −1 | −0.82 | −0.65 | −0.65 | 0.84 |

The second matrix is accompanied with a second property matrix shown in Table 6. The second property matrix comprises the same properties as the first property matrix.

TABLE 6
Property matrix of the second matrix

| row | logical | | | roaming | subscription | network | management |
|---|---|---|---|---|---|---|---|
| no | element | event type | cell id | network | type | technology | system |
| 1 | RANAP | Normal | cell 5 | not | prepaid | 3G | EMSS5 |
| | | release | | roaming | | | |
| 2 | RANAP | Fail in radio | cell 1 | not | postpaid | 3G | EMSS4 |
| | | interface | | roaming | | | |
| | | procedure | | | | | |
| 3 | BSSMAP | Radio | cell 4 | not | postpaid | 2G | EMSS5 |
| | | interface fail | | roaming | | | |
| 4 | RANAP | Invalid RAB | cell 3 | not | postpaid | 3G | EMSS5 |
| | | parameters | | roaming | | | |
| 5 | RANAP | Successful | cell 7 | not | postpaid | 3G | EMSS4 |
| | | relocation | | roaming | | | |

The property combinations of the second and the first property matrices are used for selecting a subset of the third matrix for the purpose of analyzing the second matrix. In the shown example property combinations of rows 6, 9, 7, 3 and 10 of the first property matrix correspond to the property combinations of the rows 1-5 of the second property matrix. Therefore a subset comprising rows 6, 9, 7, 3 and 10 of the third matrix is selected. The subset is shown in Table 7.

TABLE 7
Subset of the third matrix

| | | moc | | lu | call | | mtc | mtc |
|---|---|---|---|---|---|---|---|---|
| row | moc | an- | lu | at- | setup | mtc | an- | at- |
| no | drops | swers | failures | tempts | failures | drops | swers | tempts |
| 6 | −1 | −1.1 | 0.84 | 0.62 | −0.12 | −0.65 | −0.65 | −1 |
| 9 | −0.21 | −0.16 | −0.82 | −1 | −0.82 | −0.65 | −0.65 | −0.17 |
| 7 | −0.21 | −0.16 | −0.82 | −1 | −0.82 | −0.65 | −0.65 | −0.17 |
| 3 | 0.24 | 0.16 | −0.8 | −1 | −0.82 | −0.31 | −0.21 | 0.28 |
| 10 | −0.81 | −0.74 | 0.1 | 1 | 0.54 | 0.18 | −0.3 | −0.84 |

Table 8 shows fifth matrix obtained by subtracting the subset of Table 7 from the second matrix. The fifth matrix provides numerical indication of the amount of anomaly on each row of the second matrix. The fifth matrix may be output as a result of the analysis.

TABLE 8
Fifth matrix (result of the analysis)

| | | moc | | lu | call | | mtc | mtc |
|---|---|---|---|---|---|---|---|---|
| row | moc | an- | lu | at- | setup | mtc | an- | at- |
| no | drops | swers | failures | tempts | failures | drops | swers | tempts |
| 1 | 0 | 0.33 | 0.38 | 0.38 | −0.69 | −0 | 0 | −0.17 |
| 2 | −0.83 | −0.66 | 1.2 | 1 | 1.2 | −0.65 | 1.5 | −1 |
| 3 | 0.83 | 0 | 0 | 0 | 0 | −0 | −0 | 1.3 |
| 4 | 1.2 | 0.33 | −0.02 | −0 | 0 | −0.34 | −0.44 | −0.45 |
| 5 | 0.6 | 2.5 | −0.92 | −2 | −1.4 | −0.84 | −0.35 | 1.7 |

The content of the fifth matrix may be further processed to determine aggregated score for each row of the second matrix. Table 9 shows such aggregated scores for the second matrix of Table 5. In this example, the values of each row are summed to obtain the aggregated score of Table 9. The row with the highest score, i.e. row 2 in this example, may then be considered most anomalous result.

TABLE 9
Aggregate result

| row no | score |
|---|---|
| 1 | 0.22 |
| 2 | 5.8 |
| 3 | 2.2 |
| 4 | 0.28 |
| 5 | −0.64 |

Without in any way limiting the scope, interpretation, or application of the claims appearing below, a technical effect of one or more of the example embodiments disclosed herein is improved analysis of measurement results of a complex target system. Various embodiments suit well for analyzing large sets of multivariate measurement results. Such analysis is impossible or at least very difficult to implement manually. Various embodiments provide for example that process variables of a complex target system may be monitored to control whether all parameters remain stable over time. Further, various embodiments may be used in life science domain for learning normal or stable patterns from patients and for using this to detect anomalous or unstable patterns in new patients. New patients can be compared e.g. to some already analysed patients with similar profile (properties of the property matrices 401 and 406 of FIG. 4).

A further technical effect is that faster detection of anomalies in new data may be enabled. For example fitting a robust PCA model on both earlier and current data and using the resulting matrix of anomalous or unstable measurement results (the fourth matrix 304 of FIGS. 3 and 4) directly would take more time than the analysis of various embodiments.

If desired, the different functions discussed herein may be performed in a different order and/or concurrently with each other. Furthermore, if desired, one or more of the before-described functions may be optional or may be combined

Various embodiments have been presented. It should be appreciated that in this document, words comprise, include and contain are each used as open-ended expressions with no intended exclusivity.

The foregoing description has provided by way of non-limiting examples of particular implementations and embodiments a full and informative description of the best mode presently contemplated by the inventors for carrying out the solutions of the present disclosure. It is however clear to a person skilled in the art that the present disclosure is not restricted to details of the embodiments presented in the foregoing, but that it can be implemented in other embodiments using equivalent means or in different combinations of embodiments without deviating from the characteristics of the present disclosure.

Furthermore, some of the features of the afore-disclosed example embodiments may be used to advantage without the corresponding use of other features. As such, the foregoing description shall be considered as merely illustrative of the principles of the present disclosure, and not in limitation thereof. Hence, the scope of the solutions of the present disclosure is only restricted by the appended patent claims.

1. A computer implemented method for analyzing measurement results of a target system, the method comprising
receiving a first matrix comprising first measurement results of the target system;
training a matrix decomposition model with the first matrix to obtain a third matrix of normal or stable measurement results and a fourth matrix of anomalous or unstable measurement results;
receiving a second matrix comprising second measurement results of the target system, wherein the second measurement results are later measurement results compared to the first measurement results;
selecting from the third matrix a subset that matches with the second matrix;
subtracting the selected subset from the second matrix to obtain a fifth matrix;
outputting the fifth matrix or information derived from the fifth matrix for the purpose of evaluating performance of the target system to detect problems so that corrective actions can be taken, wherein the target system is a communications network, or an industrial process, wherein
each row of the matrices relates to respective one or more properties, wherein the properties define operating context in which respective measurement result is obtained, and wherein selecting the subset from the third matrix comprises selecting such rows of the third matrix that are related to at least partially the same properties with rows of the second matrix.

2. The method of claim 1, wherein the information derived from the fifth matrix comprises an aggregated score for each row of the fifth matrix.

3. The method of claim 1, wherein the first and second matrices are accompanied with a property matrix comprising a combination of properties for each row of the first and second matrices, and wherein the subset that matches the second matrix is selected based on respective combinations of properties.

4. (canceled)

5. The method of claim 1, wherein the properties comprise one or more of the following: time, location, device type, device identifier, logical element, event type, product type, production phase, production equipment, management system.

6. The method of claim 1, wherein the target system is a communications network and the properties comprise one or more of the following: time, location, subscriber type, subscription type, network technology, cell type, cell identifier, device type, device identifier, logical element, event type, antenna type, roaming network, management system.

7. The method of claim 1, wherein the first measurement results comprise measurement results for a 24 hour time period or multiple thereof.

8. The method of claim 1, wherein each row of the first and second matrices comprise measurement results aggregated over a 5-30 minute time period.

9. The method of claim 1, wherein the second measurement results comprise measurement results for a 5-30 minute time period or multiple thereof.

10. The method of claim 1, wherein the first measurement results of the first matrix comprise measurement results of a previous day and the second measurement results of the second matrix comprise at least part of measurement results of a current day.

11. The method of claim 1, wherein first measurement results and the second measurement results relate to measurement of the same phenomena over different time periods.

12. The method of claim 1, wherein the fifth matrix identifies anomalies present in the second matrix.

13. The method of claim 12, further comprising providing the identified anomalies for the purpose of performing corrective actions in the target system.

14. An apparatus comprising
a processor, and
a memory including computer program code; the memory and the computer program code configured to, with the processor, cause the apparatus to perform
receiving a first matrix comprising first measurement results of a target system;
training a matrix decomposition model with the first matrix to obtain a third matrix of normal or stable measurement results and a fourth matrix of anomalous or unstable measurement results;
receiving a second matrix comprising second measurement results of the target system, wherein the second measurement results are later measurement results compared to the first measurement results;
selecting from the third matrix a subset that matches with the second matrix;
subtracting the selected subset from the second matrix to obtain a fifth matrix;
outputting the fifth matrix or information derived from the fifth matrix for the purpose of evaluating performance of the target system to detect problems so that corrective actions can be taken, wherein the target system is a communications network, or an industrial process, wherein
each row of the matrices relates to respective one or more properties, wherein the properties define operating context in which respective measurement result is obtained, and wherein selecting the subset from the third matrix comprises selecting such rows of the third matrix that are related to at least partially the same properties with rows of the second matrix.

15. A computer program product comprising non-transitory computer executable program code which when executed by a processor causes an apparatus to perform
receiving a first matrix comprising first measurement results of a target system;
training a matrix decomposition model with the first matrix to obtain a third matrix of normal or stable measurement results and a fourth matrix of anomalous or unstable measurement results;
receiving a second matrix comprising second measurement results of the target system, wherein the second measurement results are later measurement results compared to the first measurement results;
selecting from the third matrix a subset that matches with the second matrix;
subtracting the selected subset from the second matrix to obtain a fifth matrix;
outputting the fifth matrix or information derived from the fifth matrix for the purpose of evaluating performance of the target system to detect problems so that corrective actions can be taken, wherein the target system is a communications network, or an industrial process, wherein
each row of the matrices relates to respective one or more properties, wherein the properties define operating context in which respective measurement result is obtained, and wherein selecting the subset from the third matrix comprises selecting such rows of the third matrix that are related to at least partially the same properties with rows of the second matrix.
